(19) United States
(12) Patent Application Publication
(10) Pub. No.: US 2011/0195679 A1
(43) Pub. Date: Aug. 11, 2011

(54) IC COMPONENT BENCHMARKING WITHOUT EXTERNAL REFERENCES

(75) Inventors: Cheol-Woong Lee, Santa Clara, CA (US); Sunghyun Park, Santa Clara, CA (US)

(73) Assignee: QUALCOMM INCORPORATED, San Diego, CA (US)

(21) Appl. No.: 12/788,109

(22) Filed: May 26, 2010

Related U.S. Application Data
(60) Provisional application No. 61/303,653, filed on Feb. 11, 2010.

(51) Int. Cl. H04B 17/00

(52) U.S. Cl. 455/115.1

(57) ABSTRACT

Resistors and capacitors of an integrated circuit (IC) are calibrated without an external reference resistor. The IC includes a tunable circuit element and a benchmarking circuit. The benchmarking circuit includes a target component and an internal reference component. The internal reference component exhibits a lower sensitivity to changes in test conditions than the target component. The benchmarking circuit is useable to measure benchmarking metric values associated with the internal reference and the target. In one example, a first benchmarking metric value is measured while an internal reference component participates in the circuit and a second benchmarking metric value is measured while a target component participates in the circuit. A benchmark value is calculated based on the measured values and systemic, parasitic errors of the benchmarking circuit are canceled. The benchmark value is used to calculate a new tuning code of the tunable circuit element present on the IC.

### RELATED APPLICATIONS

### Claim of Priority Under 35 U.S.C. §119

The present application for patent claims priority to Provisional Application No. 61/303,653 entitled “IC Component Benchmarking Without External References” filed Feb. 11, 2010, and assigned to the assignee hereof and hereby expressly incorporated by reference herein.

### BACKGROUND INFORMATION

1. Technical Field

The present disclosure relates to wireless communication systems, and more particularly tuning of integrated circuits of a mobile communication device without external references.

2. Background Information

Examples of components external to an integrated circuit include external resistors and capacitors. External reference resistors are often used as the standard for calibrating voltage sources, current sources, and other elements within a circuit. The calibration of these circuit elements often occurs in a factory environment. But as conditions change during the lifetime of a mobile communication device, it is desirable to recalibrate many circuit elements as the mobile communication device is being used by the consumer. In some applications, it is acceptable to include external reference components with the electronic device for use as calibration standards. But, as mobile communication devices with increased functionality and smaller size are designed to meet consumer demand, it is becoming increasingly difficult to include external reference components. As the level of circuit integration increases to accommodate an increasing number of circuit functions in a smaller size, external components now occupy an amount of space that is comparable to the size of many of the integrated circuits of a mobile communication device. In addition, external components are a significant component of the cost of the circuitry of a mobile communications device. Thus, electronic circuitry with a reduced number of external reference components is desirable.

### SUMMARY

An Integrated Circuit (IC) includes an internal reference component, a target component, and a tunable circuit element. The internal reference component exhibits a lower sensitivity to changes in conditions (e.g. process, temperature, and voltage variations) than the target component. Because of its lower sensitivity, the internal reference component may be used to benchmark the target component. A benchmark value is calculated to characterize a change in performance of the target component with reference to the relatively stable internal reference component. Tunable circuit elements with a sensitivity to changes in conditions similar to the target component are calibrated based at least in part on the benchmark value.

The internal reference component and the target component are present within a benchmarking circuit. The benchmarking circuit generates a benchmarking metric indicative of a performance of the benchmarking circuit during operation. For a particular circuit configuration, the benchmarking circuit generates a benchmarking metric value. In at least one configuration, the internal reference component participates in the benchmarking circuit and a first benchmarking metric value is generated. In at least a second configuration, the target component participates in the benchmarking circuit and a second benchmarking metric value is generated. In some examples, both the target and internal reference components participate in the benchmarking circuit and one or more benchmarking metric values are generated. The benchmark value is calculated based at least in part on at least one benchmarking metric value generated by the benchmarking circuit.

In a first embodiment, the benchmarking circuit is a single ended harmonic oscillator. The characteristic time constant of the oscillator is the benchmarking metric and is based on the characteristic resistance, R, and capacitance, C, of the circuit. The benchmarking circuit is part of an FM transceiver IC and its configuration is programmable. In a first configuration, an internal reference component including metal-oxide-silicon (MOS) capacitors participates in the benchmarking circuit. In a second configuration, a target component including metal-oxide-metal (MOM) capacitors participates in the benchmarking circuit. The MOS capacitors exhibit lower sensitivity to changes in test conditions than the MOM capacitors. A first benchmarking metric value is generated based on benchmarking circuit operating in the first configuration and second benchmarking metric value is generated based on benchmarking circuit operating in the second configuration. Based at least in part on these values, a first benchmark value is calculated. The benchmark value is useable to calibrate tunable circuit elements present on the FM transceiver IC that include MOM capacitors. In another example, a second benchmark value is calculated based at least in part on the first benchmarking metric value. This benchmark value is useable to calibrate tunable circuit elements present on the FM transceiver that includes resistors.

In a second embodiment, the benchmarking circuit includes at least one MOS capacitor and at least one MOM capacitor. A supply current charges the MOS capacitor and a supply current of the same value charges the MOM capacitor. Both capacitors are charged for the same fixed period of time. A first benchmarking metric value is the potential across the MOS capacitor after the fixed period of time and the second benchmarking metric value is the potential across the MOM capacitor after the fixed period of time. Based at least in part on these values, a benchmark value is calculated. The benchmark value is useable to calibrate tunable circuit elements present on the FM transceiver IC that include MOM capacitors.

In a third embodiment, the benchmarking circuit is configured in a manner similar to the second embodiment, except the target component is a tunable capacitor network of MOM capacitors and the internal reference component includes at least one MOS capacitor. In addition, a capacitor selection signal determines a configuration of the tunable capacitor network. Benchmarking metric values indicative of the potential across each capacitor network are generated by the benchmarking circuit. A tuning algorithm determines a difference between the two benchmarking metric values to generate a benchmark value. Next, the tuning algorithm selects a new code useable to change the configuration of tunable capacitor network based on the benchmark value. The configuration of the tunable capacitor network is changed in response to code and the benchmarking metric values are generated again based on the new configuration. This is repeated until the difference in potential between the two capacitor networks converges. Thus, the capacitance of the MOM capacitor network is iteratively calibrated to the MOS capacitor based on successively calculated benchmark values.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 is a simplified block diagram of a benchmarking metric measurement module (BMMM) 43 in an FM transceiver 12 of a mobile communication device 10.

FIG. 2 is a more detailed block diagram of the FM transceiver 12 of FIG. 1.

FIG. 3 is a more detailed block diagram of a first embodiment of BMMM 43 of the FM transceiver 12 of FIG. 1. The BMMM 43 includes a benchmarking circuit 66 that outputs measurements useful for benchmarking target components with internal reference components.

FIG. 4 is a simplified waveform diagram that illustrates how BMMM 43 measures the oscillation frequency of the benchmarking circuit 66 of FIG. 3.

FIG. 5 is a simplified block diagram of a tunable capacitor network 63, a tunable current scaling network 61, and a tunable resistor network 62 that are tuned based on control signals communicated from control logic 58.

FIG. 6 is a simplified diagram that illustrates the change in capacitance of tunable capacitor network 63 over changing conditions, and how a shift in the control code of the tunable capacitor network can compensate for the change in capacitance.

FIG. 7 is a more detailed diagram of tunable capacitor network 63 and the tuning of this network.

FIG. 8 is a more detailed diagram of tunable current scaling network 61 and the tuning of this network.

FIG. 9 is a more detailed diagram of tunable resistor network 62 and the tuning of this network.

FIG. 10 is a more detailed block diagram of a second embodiment of BMMM 43 of the FM transceiver 12 of FIG. 1. The BMMM 43 includes a benchmarking circuit 66 that outputs measurements useful for benchmarking target components with internal reference components.

FIG. 11 is a more detailed block diagram of a third embodiment of BMMM 43 of the FM transceiver of FIG. 1.

FIG. 12 is a flowchart of a method of tuning circuit elements to compensate for changing conditions based on benchmarking target components with internal reference components.

### DETAILED DESCRIPTION

A benchmarking metric measurement module (BMMM) of an Integrated Circuit (IC) that generates benchmarking metric values is disclosed. The BMMM includes at least one internal reference component with a sensitivity to changes in test conditions that is lower than a target component to be benchmarked on the IC. Methods for calculating benchmark values based at least in part on the benchmarking metric values generated by the BMMM are disclosed. The benchmark values are useable to compensate for changes in conditions that affect the performance of the tunable circuit elements. Tunable circuit elements are calibrated based at least in part on the benchmark value. The tunable circuit elements include components similar to target components benchmarked to the internal reference component of the BMMM. In this manner, tunable circuit elements of the IC may be calibrated to compensate for changes in conditions without external reference components.

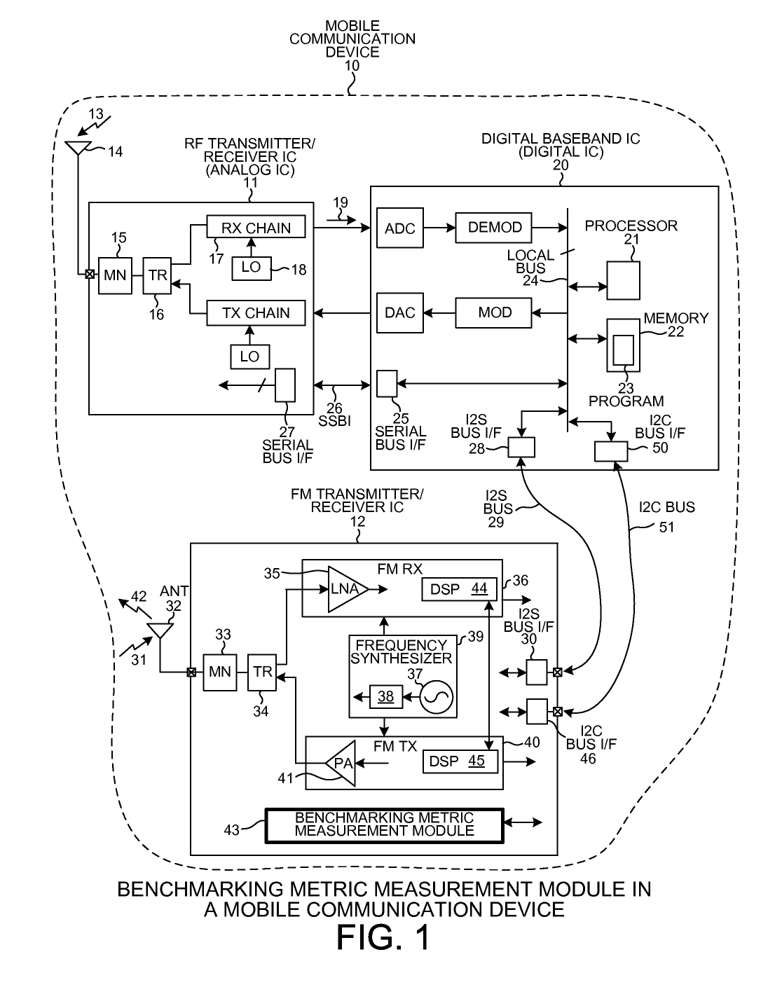

FIG. 1 is a diagram of a mobile communication device 10 that employs a BMMM 43. In this particular example, mobile communication device 10 is a cellular telephone. In another example, mobile communication device 10 is an RF-enabled personal digital assistant (PDA). Mobile communication device 10 includes an RF transceiver integrated circuit (IC) 11 and an FM transceiver IC 12. Each of transceivers 11 and 12 is called a “transceiver” because it includes a transmitter as well as a receiver.

A first signal 13 is received onto an RF receiver of mobile communication device 10. In one embodiment, first signal 13 is a radio frequency signal transmitted by a base station. First signal 13 is received onto antenna 14, passes through a matching network (MN) 15, passes through a Transmit/Receive (TR) switch 16, and is processed by the receive chain 17 of RF transceiver IC 11. The receive chain 17 uses a Local Oscillator (LO) signal generated by a local oscillator 18 to downconvert first signal 13 to a baseband signal 19 for subsequent digital signal processing by a digital baseband IC 20. In one implementation, a BMMM could be advantageously employed as part of RF transceiver IC 11 and benchmarking metric values generated by the BMMM could be used to calculate a benchmark value useable to calibrate tunable circuit elements of RF transceiver IC 11 (e.g. local oscillator 18).

Digital baseband IC 20 includes, among other parts not illustrated, a digital processor 21 that executes instructions stored in a processor-readable medium 22. For example, processor-readable medium 22 includes program memory that stores instructions of a computer program 23 that, when executed, control the benchmarking of target components and calibration of tunable circuit elements based at least in part on a benchmark value calculated from benchmarking metric values generated by the BMMM. In one embodiment, processor 21 causes information to be communicated across a parallel local bus 24, a serial bus interface 25 and a serial bus 26 to a serial bus interface 27 of RF transceiver IC 11. Thus, processor 21 may control the calibration of tunable circuit elements of RF transceiver IC 11. In another embodiment, processor 21 causes information to be communicated across a parallel local bus 24, a serial bus interface 50 and a serial bus 51 to serial bus interface 46 of FM transceiver IC 12. Thus, processor 21 may control the calibration of tunable circuit elements of FM transceiver IC 12.

A second signal 31 is received on mobile communication device 10. Second signal 31 is an FM radio frequency signal transmitted by a radio station in the FM radio band from 76-108 MHz. Where mobile communication device 10 is used in the United States, Canada or Europe, the frequency of second signal 31 falls within a frequency range from 87.5 MHz to 108.0 MHz. Where mobile communication device 10 is used in Japan, the frequency of second signal 31 falls within a frequency range from 76 MHz to 90 MHz. In one implementation, second signal 31 is received onto an antenna 32 that is printed on the printed circuit board (PCB) onto which FM transceiver IC 12 is mounted. The size of the printed circuit board is limited within mobile communication device 10, and therefore the length of antenna 32 is also limited. In another implementation, where better FM radio reception is desired by using a longer antenna, the user of mobile communication device 10 may use a longer headset wire antenna integrated into the wire that connects the headset or earplug to mobile communication device 10 (not shown). Where second signal 31 is received onto antenna 32, second signal 31 passes through a matching network (MN) 33, passes through TR switch 34, is received and amplified by Low Noise Amplifier (LNA) 35 of FM receiver 36, and is further processed by FM receiver 36. To process second signal 31, FM receiver 36 uses an oscillatory signal generated by a Voltage Controlled Oscillator (VCO) 37 and a programmable output divider 38 of frequency synthesizer 39. The processed and digitized audio signals are then communicated from FM receiver 36 via an Inter-IC Sound (I2S) bus interface 30, over serial bus 29, to serial bus interface 28 of digital baseband IC 20. The signals are further processed by digital baseband IC 20 before being transmitted to a speaker on mobile communication device 10 or to a headset or earplug. In another embodiment, some of the digital processing of the digitized audio signals is performed on processors 44-45 located on FM transceiver IC 12. FM transceiver IC 12 also has an FM transmitter 40 that can transmit audio signals received via I2C serial bus 46 from digital baseband IC 20. FM transmitter 40 uses a VCO signal generated by a VCO 37 of frequency synthesizer 39. A signal to be transmitted is amplified by power amplifier 41, passes through TR switch 34, matching network 33, and is transmitted over antenna 32 as signal 42.

In the example illustrated, FM transceiver IC 12 includes benchmarking metric measurement module (BMMM) 43. In one implementation, tunable circuit elements of FM transceiver IC 12 may be calibrated based at least in part on a benchmark value calculated from benchmarking metric values generated by BMMM 43. For example, tunable circuit elements of any of VCO 37, LNA 35, PA 41, MN 33, and other circuitry of FM receiver 36 and FM transmitter 40 may be calibrated. In one embodiment, processor 21 may control the calibration of tunable circuit elements of FM transceiver IC 12. Processor 21 receives benchmarking metric values from BMMM 43, calculates control values based at least in part on a benchmark value calculated from the benchmarking metric values, and causes control information to be communicated across parallel local bus 24, through bus interface 50, over bus 51, and to bus interface 46 of FM transceiver IC 12. In another embodiment, a second processor 44 or a third processor 45 located in FM transceiver IC 12 control the calibration of tunable circuit elements of FM transceiver IC 12. For example, processor 21 executes instructions that calibrate the matching network 33 of FM transceiver IC 12, whereas processors 44 and 45 in the FM transceiver IC 12 execute instructions that calibrate LNA 35 and PA 41 respectively.

The term “computer” encompasses processor 21 that executes “code” (computer program 23) of instructions stored in memory 22 (a computer-readable medium). The term “computer” also encompasses the second and third processors 44-45 located in FM transceiver IC 12.

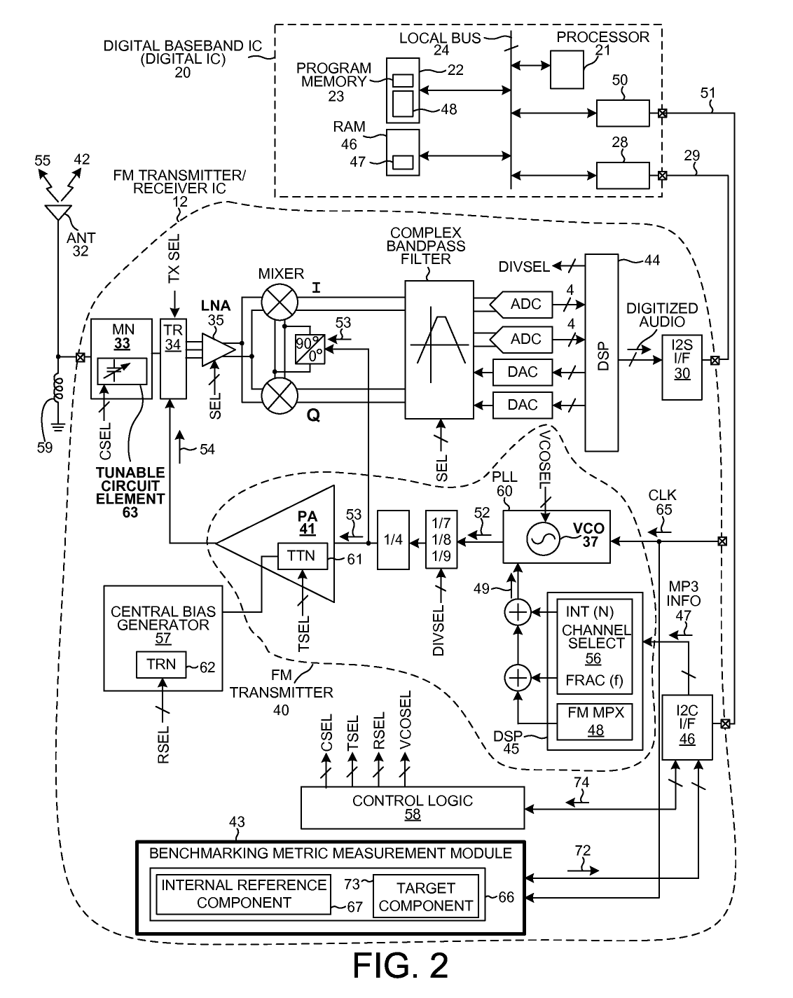

FIG. 2 illustrates FM transceiver IC 12 in more detail and shows how processor 21 controls the operation of BMMM 43, processes benchmarking metric values 72 received from BMMM 43, and communicates control values 74 to calibrate tunable circuit elements of FM transceiver IC 12 based at least in part on the benchmarking metric values received from BMMM 43. FIG. 2 demonstrates the method of benchmarking target components 73 of an IC using internal reference components 67 of the IC in the context of an FM transceiver IC 12, which transmits FM radio signals in the 76 MHz-108 MHz frequency band.

In one embodiment, FM transceiver IC 12 is used to transmit FM radio signals. In a receive mode, the divider (N+f) of PLL 60 is fixed to correspond to the FM radio station from which radio signals are being received. In a transmit mode, the (N+f) value is modulated to generate a FM radio signal 55 that is transmitted. For example, the user may wish to play songs on a car radio that are stored in MP3 format on mobile communication device 10. To play an MP3 recording, MP3 information 47 is communicated from digital baseband IC 20 via I2C serial bus 51 to FM transceiver IC 12. Digital computation block 48 receives the MP3 information, processes it, and generates divider setting signal 49 with modulated (N+f) values. VCO 37 then outputs VCO signal 52 that is modulated around a higher frequency according to design preference. Frequency synthesizer 39 then outputs synthesizer signal 53 that has been divided down in frequency based on control signal DIVSEL. For example, if no radio station transmits at 95.5 MHz in the area in which the user is driving, then the user can set the mobile communication device 10 to transmit a radio signal at 95.5 MHz to the car radio that plays the songs that are recorded in MP3 format on mobile communication device 10. The radio signal at 95.5 MHz is generated from a VCO signal 52 with modulation around the frequency 3056 MHz that is divided by thirty-two, (second divider eight). Synthesizer signal 53 at 95.5 MHz containing modulated MP3 information passes through power amplifier 41 and is communicated as a radio transmission 54 at 95.5 MHz to antenna 32. Radio transmission 54 is transmitted from antenna 32 as FM radio signal 55 a short distance to the FM receiver of the car radio, and the MP3 songs play on the car radio channel at 95.5 MHz.

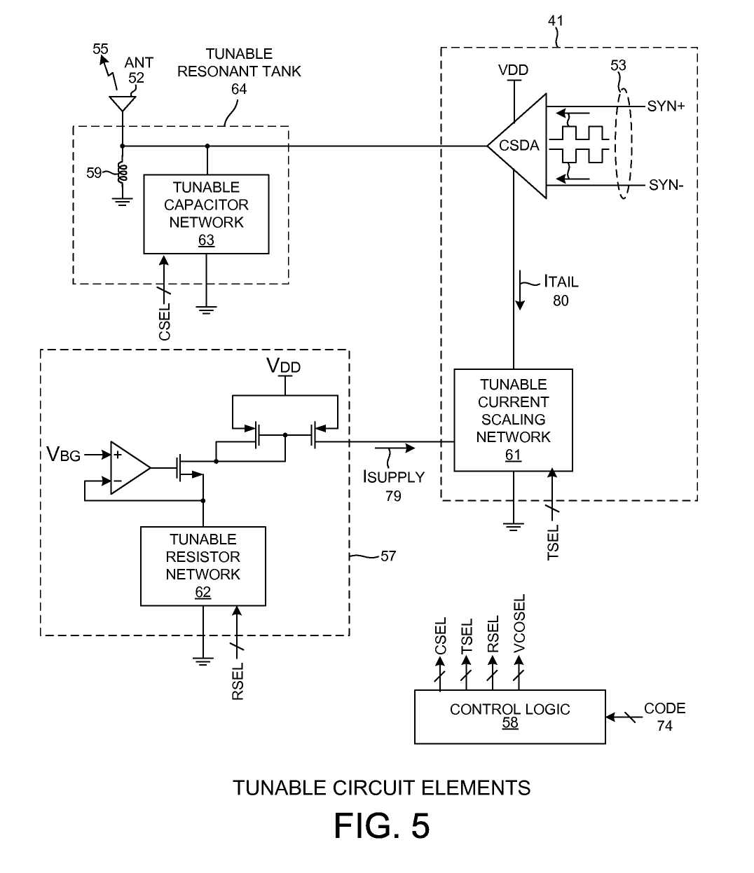

A number of tunable circuit elements of FM transmitter 40 may be calibrated based at least in part on a benchmark value calculated from benchmarking metric values generated by BMMM 43. In one example, oscillatory signal 52 is set to a desired frequency by setting the divider (N+f) of PLL 60. Processor 21 sets the divider (N+f) by controlling a channel select block 56 within processor 45 of FM transceiver IC 12. Channel select block 56 outputs an integer output (N) and a fractional output (f) that are combined into a divider setting signal 49 that sets the appropriate (N+f) value. By adjusting the (N+f) value received by PLL 60 the frequency generated by an LC tank (not shown) of VCO 37 is changed by operation of PLL 60. The LC resonant tank of VCO 37 may be calibrated by adjusting the capacitance of a tunable capacitor bank (not shown) within VCO 37 based on control signal VCOSEL. In another example, power amplifier 41 includes a tunable transistor network that can be used to scale current received from central bias generator 57. The tunable transistor network is calibrated based on control signal TSEL. In another example, central bias generator 57 includes a tunable resistor network that can be used to adjust current delivered from central bias generator 57 to any circuit block of FM transceiver IC 12, including PA 41. The tunable resistor network is calibrated based on control signal RSEL. In another example, Matching Network (MN) 33 includes a tunable capacitor network 63. Together with external inductor 59, the tunable capacitor network 63 forms a tunable LC resonant tank 64 (see FIG. 5) useful for conversion of square wave radio transmission signal 54 into a sinusoidal signal. The capacitance of tunable capacitor network 63, and thus the resonant frequency of tunable LC resonant tank 64, is calibrated based on control signal, CSEL. TSEL, RSEL, CSEL, and VCOSEL are generated by control logic 58 and are based at least in part on a benchmark value calculated based on benchmarking metric values generated by BMMM 43.

In one example, the output voltage variation of the FM transmitter 40 should be less than 4 dB in the 76 MHz to 108 MHz frequency band. To maintain low output voltage variation, both the tail current of PA 41 and the resonant frequency of LC resonant tank 64 must be calibrated. Conditions vary over the operational lifetime of mobile communication device 10 that alter both the tail current of PA 41 and the resonant frequency of LC resonant tank 64. These variations are compensated by control values TSEL and CSEL communicated from control logic 58 to maintain the output voltage variation of the FM transmitter 40 to less than 4 dB in the 76 MHz to 108 MHz frequency band. These control values are based at least in part on a benchmark value calculated from benchmarking metric values generated by BMMM 43.

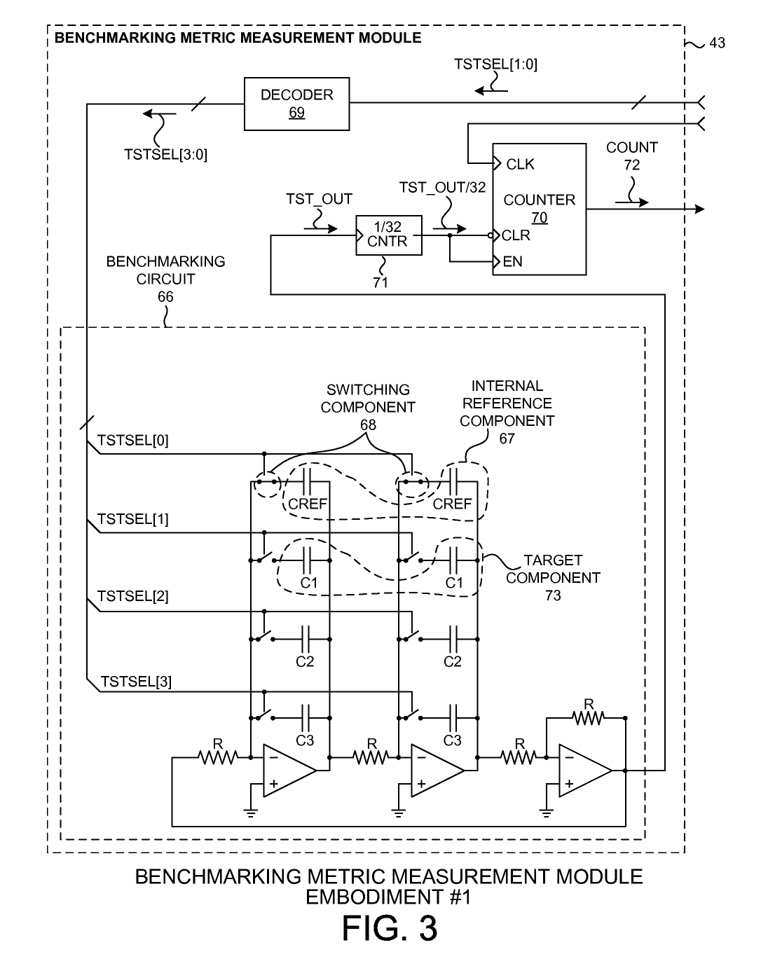

FIG. 3 illustrates BMMM 43 in one embodiment. BMMM 43 is present within FM transceiver IC 12. BMMM 43 includes at least one internal reference component 67 with a sensitivity to changes in conditions that is lower than a target component 73 to be benchmarked on IC 12. BMMM 43 generates benchmarking metric values 72 useable to calculate benchmark values. BMMM 43 includes benchmarking circuit 66, decoder block 69, downcounter block 71, and counter block 70. BMMM 43 is operable to receive a test control signal (TSTSEL[1:0]) and a clock signal (CLK), and output a COUNT signal 72. In the present example, benchmarking circuit 66 is a single ended harmonic oscillator that produces a sine wave output signal. Benchmarking circuit 66 includes a characteristic resistance, R, and capacitance, C. Ideally, benchmarking circuit 66 outputs an oscillatory signal, TST_OUT, with a period of oscillation, τ˜RC. In the present embodiment, the benchmarking metric of benchmarking circuit 66 is the period of oscillation associated with the sine wave output signal of benchmarking circuit 66. In operation, benchmarking circuit 66 outputs an oscillatory signal, TST_OUT, with a period of oscillation, τ=RC(1+α). Parameter, α, is representative of non-ideal behavior of benchmarking circuit 66. Parasitic resistance and capacitance from the wires and the finite gain-bandwidth product of the operational amplifiers of benchmarking circuit 66 introduces approximately 6% inaccuracy (max-min) in the estimation of the RC time constant, τ. The unit cells of capacitors of benchmarking circuit 66 (e.g. internal reference component 67 and target component 73) can be selectively switched by test control signal TSTSEL. The test control signal TSTSEL[1:0] is a two bit binary signal generated by processor 21 and communicated to BMMM 43. Decoder 69 receives test control signal TSTSEL[1:0], decodes this signal, and outputs corresponding binary digital control signals TSTSEL[3:0] that control switching components of benchmarking circuit 66. By alternatively closing each pair of switching components, different pairs of capacitors participate in benchmarking circuit 66. One pair of capacitors illustrated is internal reference component 67. In the present example, internal reference component 67 is a pair of MOS capacitors each with a nominal capacitance value of approximately one picofarad. MOS capacitors are selected as the internal reference component because they exhibit relatively low sensitivity to changes in conditions. A second pair of capacitors illustrated is target component 73. In the present example, target component 73 is a pair of MOM capacitors each with a nominal capacitance value of approximately one picofarad. MOM capacitors exhibit relatively high sensitivity to changes in conditions. It is desirable to benchmark the MOM capacitors to the MOS capacitors by calculating a benchmark value useable to calibrate tunable circuit elements of IC 12 that include MOM capacitors, and thus compensate for changes in conditions. Other types of capacitors present on IC 12 with relatively high sensitivity to process variations may be included as second and third target components.

Changes in conditions include process, voltage, and temperature (PVT) variations that impact the performance characteristics of electrical components (e.g. resistors and capacitors) of the IC. An example of a process variation is the variation in a manufacturing process. For example, a capacitor may be specified as part of IC, but due to manufacturing process variations the specified capacitor of each manufactured IC may exhibit a slightly different capacitance. Different components may be more or less sensitive to PVT variations. In one example, an IC may employ Metal-Oxide-Metal (MOM) capacitors or Metal Oxide on Silicon (MOS) capacitors. MOS capacitors exhibit relatively low sensitivity to process and temperature variation. Table 1 illustrates a comparison between the percentage changes in capacitance from typical test conditions of both a MOS capacitor and a MOM capacitor due to both process and temperature variation. Columns 2-6 of Table 1 represent five sets of test conditions under which the capacitance of both a MOS and MOM capacitor are measured. In this example, the impact of manufacturing process variation is captured by choosing test components from a group of manufactured components. The “typical” test capacitors are selected such that they exhibit a capacitance value that is typical of the group. The “fast” test scenario captures the process condition where the capacitance value of the MOM capacitors is at a minimum, the capacitance value of the MOS capacitors is at a maximum, and the resistance value of the P+ polysilicon (PP) resistors of benchmarking circuit 66 is at a minimum. The “slow” test scenario captures the process condition where the capacitance value of the MOM capacitors is at a maximum, the capacitance value of the MOS capacitors is at a minimum, and the resistance value of the P+ polysilicon (PP) resistors of benchmarking circuit 66 is at a maximum. The second row of Table 1 represents the temperature condition during each test. The third and fourth rows illustrate the capacitance values for each test for MOS and MOM capacitors, respectively. In this example, MOS capacitors exhibit only 9% variation (max-min), in capacitance over a range of process and temperature conditions, whereas MOM capacitors exhibit 30% variation (max-min) in capacitance over the same range of test conditions.

TABLE 1
Process and temperature variation of MOM and MOS capacitors

Process

| | | | | |
|---|---|---|---|---|
| Typical | Fast | Fast | Slow | Slow |

Temp

| | 55 C. | 110 C. | −30 C. | 110 C. | −30 C. |
|---|---|---|---|---|---|
| MOS | 0% | +4.3% | +3.6% | −3.6% | −4.3% |
| MOM | 0% | −15% | −15% | +15% | +15% |

But, MOS capacitors also exhibit poor linearity relative to MOM capacitors over a range of operating frequencies present on an IC. MOM capacitors may be used as part of a tunable circuit element within the IC to obtain the advantage of their relative linearity. To mitigate their relatively high sensitivity to changes in test conditions, the MOM capacitors are benchmarked to MOS capacitors present on the IC. The benchmarking of the MOM capacitors to the MOS capacitors results in a benchmark value useable to calibrate a tunable circuit element on the IC that includes MOM capacitors, and thus compensate for changes in performance of the MOM capacitors due to changes in test conditions (e.g. variations in temperature and process).

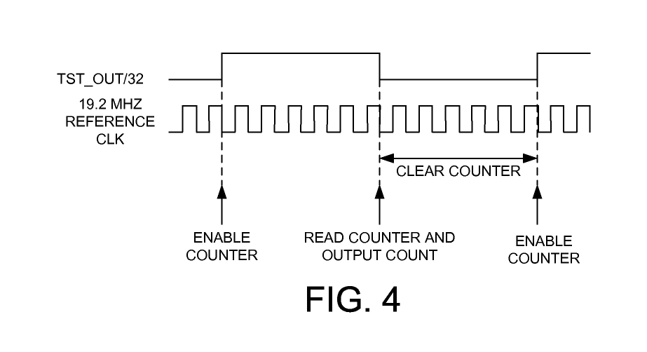

The output signal, TST_OUT, of benchmarking circuit 66 is processed by BMMM 43 to generate a benchmarking metric value 72 that is communicated to digital baseband IC 20. In the present example, benchmarking metric value 72 is a COUNT value indicative of the time constant of benchmarking circuit 66 for a given configuration. Output signal, TST_OUT, is an oscillatory signal that is downcounted by a factor of 32 by downcounter block 71. Counter 70 determines how many cycles of clock signal CLK received on BMMM 43 occur within a half period of downcounted signal TST_OUT/32. As illustrated in FIG. 4, counter circuit 70 is enabled on each rising edge of divided down output signal TST_SEL/32. Counter 70 then counts the number of cycles of reference clock signal CLK until the next falling edge of downcounted signal TST_OUT/32 is reached. Counter 70 therefore counts during the high portion of the TST_OUT/32 signal illustrated in FIG. 4. Counter 70 outputs the measured count signal COUNT, and is then held in the cleared state until the next rising edge of TST_OUT/32 is reached. Signal COUNT is communicated to processor 21.

The time period of oscillation of benchmarking circuit 66 is

T=2πRC(1+α) (1)

For a clock signal oscillating at a frequency of 19.2 MHz, the time period measured by counter 70 is

$${T}_{measured} = \frac{COUNT}{19.2 e 6} \qquad ( 2 )$$

During the measurement time period, T_{measured}, benchmarking circuit 66 has oscillated sixteen times. Thus, the time period of oscillation of benchmarking circuit 66 can be calculated by digital baseband IC 20 as

$$T = 2 π RC ( 1 + α ) = \frac{COUNT}{( 16 ) ( 19.2 e 6 )} \qquad ( 3 )$$

The time constant of an RC oscillator circuit may be defined as

τ=RC(1+α) (4)

Thus, the time constant of benchmarking circuit 66 may be calculated by digital baseband IC 20 as

$$τ = RC ( 1 + α ) = \frac{COUNT}{( 16 ) ( 2 π ) ( 19.2 e 6 )} \qquad ( 5 )$$

In this manner, benchmarking metric value 72 is indicative of the time constant of benchmarking circuit 66 for a given configuration.

As illustrated in FIG. 3, in a first configuration of benchmarking circuit 66, control signal TSTSEL[0] maintains switching components 68 in a closed state, while control signals TSTSEL[1], TSTSEL[2], and TSTSEL[3] maintain the switching components under their control in an open state. Thus, only internal reference component 67 participates in benchmarking circuit 66 and the time constant of output signal TST_OUT is τ=RC_{ref}(1+α₁). In a second configuration, control signal TSTSEL[1] maintains the switching components under its control in a closed state, while control signals TSTSEL[0], TSTSEL[2], and TSTSEL[3] maintain the switches under their control in an open state. Thus, only target component 73 participates in benchmarking circuit 66 and the time constant of output signal TST_OUT in the second measurement is τ=RC₁(1+α₂). In the present example, internal reference component 67 is a pair of MOS capacitors each with a capacitance value of approximately one picofarad. The resistors of benchmarking circuit 66 exhibit a resistance of approximately one hundred kiloohms. As benchmarking circuit 66 oscillates, BMMM 43 communicates a COUNT value representative of the time constant of benchmarking circuit 66 in this configuration to digital baseband IC 20. Processor 21 calculates a time constant of benchmarking circuit 66 as discussed above for this configuration of benchmarking circuit 66 and stores this value in portion 47 of random access memory 46 (see FIG. 2).

τ_{MOS,test}=RₜₑₛₜC_{MOS,test}(1+α₁) (6)

Similarly, processor 21 communicates a second test selection signal to BMMM 43. BMMM 43 responds by selecting a target component 73 of benchmarking circuit 66 as the element under test. Thus, in this second configuration, target component 73 participates in benchmarking circuit 66. In the present example, the target component is a pair of MOM capacitors each with a capacitance value of approximately one picofarad. As benchmarking circuit 66 oscillates, BMMM 43 communicates a COUNT value representative of the time constant of benchmarking circuit 66 in this configuration to digital baseband IC 20. Processor 21 calculates a time constant of benchmarking circuit 66 as discussed above for the case where a MOM capacitor is selected as the component under test and stores this value in a portion of memory 47.

τ_{MOM,test}=RₜₑₛₜC_{MOM,test}(1+α₂) (7)

In manufacture, a number of ICs, each with a benchmarking circuit 66, are measured in both the configuration where the MOS capacitors participate and the configuration where the MOM capacitors participate. The results are averaged to calculate a nominal time constant of benchmarking circuit 66 for both each configuration.

τ_{MOS,nom}=RₙₒₘC_{MOS,nom}(1+αₙₒₘ) (8)

τ_{MOM,nom}=RₙₒₘC_{MOM,nom}(1+αₙₒₘ) (9)

These values are stored in a nonvolatile memory such as portion 48 of memory 22.

In the present example, a benchmark value, λ, is defined as the ratio of the capacitance of the MOM capacitor under nominal conditions to the capacitance of the MOM capacitor tested during the operational lifetime of mobile communication device 10. Thus, benchmark value, λ, is useable to characterize a change in capacitance of the MOM capacitor from nominal conditions.

$$λ = \frac{{C}_{MOM , nom}}{{C}_{MOM , test}} \qquad ( 10 )$$

Benchmark value, λ, is a useful metric for calibrating tunable circuit elements of FM transceiver IC 12. Based on equations (6-9) and the definition of equation (10), benchmark value, λ, can be expressed as follows:

$$λ = \frac{{τ}_{MOM , nom}}{{τ}_{MOM , test}} \cdot \frac{{τ}_{MOS , test}}{{τ}_{MOS , nom}} \cdot \frac{{C}_{MOS , nom}}{{C}_{MOS , test}} \cdot \frac{( 1 + {α}_{2} )}{( 1 + {α}_{1} )} \qquad ( 11 )$$

In a first approximation, it is assumed that the PVT variation of a MOS capacitor is negligible within an acceptable error range. Under this assumption, benchmark value, λ, can be expressed as follows:

$$λ \approx \frac{{τ}_{MOM , nom}}{{τ}_{MOM , test}} \cdot \frac{{τ}_{MOS , test}}{{τ}_{MOS , nom}} \cdot \frac{( 1 + {α}_{2} )}{( 1 + {α}_{1} )} \qquad ( 12 )$$

In a second approximation, the parasitic effects associated with the wires and operational amplifiers of benchmarking circuit 66 during test conditions of the MOS capacitors and MOM capacitors are presumed to be the same. Under this assumption, benchmark value, λ, can be expressed as follows:

$$λ \approx \frac{{τ}_{MOM , nom}}{{τ}_{MOM , test}} \cdot \frac{{τ}_{MOS , test}}{{τ}_{MOS , nom}} \qquad ( 13 )$$

For a given PVT condition during test, the parasitic effects are almost identical for both configurations of benchmarking circuit 66. This is because both tests are performed using the same test circuit employing the same operational amplifier components. In this manner, benchmark value, λ, may be calculated with minimal influence from the systemic, parasitic errors of benchmarking circuit 66. For example, presuming that τ_{MOS} is measured with a parasitic error of +3.1% and τ_{MOM} is measured with a parasitic error of +2.9%, the error induced in the calculation of λ is less than 0.2%. Thus, in the case where parasitic errors of the measurement circuit are +/−3%, the calculation of benchmark value, λ, is practically unaffected. This stands in contrast to the case where an external resistor is used. For the case of calibration with an external resistor, the systemic, parasitic errors of the benchmarking circuit are not cancelled. Even with a perfectly stable external resistor, the parasitic errors introduced by the benchmarking circuit are directly reflected in the measurement result, thus limiting tuning accuracy. However, by benchmarking to an internal reference component as discussed above, the systemic errors of the benchmarking circuit are largely cancelled. Thus, the tuning accuracy is primarily limited by the PVT variation of the internal reference component, rather than the systemic errors of the benchmarking circuit.

Benchmark value, λ, is calculated based on stored values and the first and second benchmarking metric values 72. As discussed above, the time constants τ_{MOM,nom} and τ_{MOS,nom} of equation (13) are stored in memory (e.g. memory 48). As illustrated in equation (5), τ_{MOS,test} and τ_{MOM,test} can be calculated based on the COUNT value generated by benchmarking circuit 66 in the first configuration and the COUNT value generated by benchmarking 66 in the second configuration, respectively. In this manner, a benchmark value is calculated that is useable to tune circuit elements employing MOM capacitors present on FM transceiver 12.

Digital baseband IC 20 may also calculate a benchmark value, γ, useful for tuning resistors present on FM transceiver 12. Benchmark value, γ, is defined as the ratio of the resistance of the resistors of benchmarking circuit 66 when the resistors are tested during the operational lifetime of mobile communication device 10 to the nominal resistance of the resistors.

$$γ = \frac{{R}_{test}}{{R}_{nom}} \qquad ( 14 )$$

Based on equations (6) and (8) and the definition of equation (14), benchmark value, γ, may be expressed as follows:

$$γ = \frac{{τ}_{MOS , test}}{{τ}_{MOS , nom}} \cdot \frac{{C}_{MOS , nom} ( 1 + {α}_{nom} )}{{C}_{MOS , test} ( 1 + {α}_{1} )} \qquad ( 15 )$$

In a first approximation, it is assumed that the PVT variation of a MOS capacitor is negligible within an acceptable error range. In a second approximation, the parasitic effects associated with the wires and operational amplifiers of benchmarking circuit 66 during test conditions of the MOS capacitors is presumed to be negligible. Under this assumption, benchmark value, γ, can be expressed as follows:

$$γ \approx \frac{{τ}_{MOS , test}}{{τ}_{MOS , nom}} \qquad ( 16 )$$

Benchmark value, γ, is calculated based on a stored value and the first benchmarking metric value 72. As discussed above, the time constant τ_{MOS,nom} of equation (16) is stored in memory (e.g. memory 48). As illustrated in equation (5), τ_{MOS,test} may be calculated based on the COUNT value generated by benchmarking circuit 66 in the first configuration. In this manner, a benchmark value is calculated that is useable to tune circuit elements employing resistors present on FM transceiver 12. In this manner, the resistance of the benchmarking circuit 66 is the target component that is benchmarked to the MOS capacitors.

Benchmark values, λ and γ, can be used in several ways to compensate for changes in conditions in tunable circuit elements of FM transceiver IC 12. FIG. 5 illustrates central bias generator 57, power amplifier 41, and tunable resonant tank 64 of FM transceiver IC 12. Tunable resonant tank 64 includes a tunable capacitor network 63. Central bias generator 57 includes a tunable resistor network 62. Power amplifier 41 includes a tunable current scaling network 61. Control logic 58 receives a CODE signal from digital baseband IC 20 that includes a control value calculated by processor 21 based at least in part on at least one benchmark value such as λ and γ. In response, control logic 58 communicates a signal to a tunable circuit element that causes the configuration of the tunable circuit element to be changed. In this manner, the control value calculated at least in part on a benchmark value is useable to change the configuration of tunable circuit element. In one example, control logic 58 outputs control signal CSEL to calibrate the capacitance of capacitor network 63 based on the CODE signal. In a second example, control logic 58 outputs control signal TSEL to calibrate a network of transistors of current scaling network 61 based on the CODE signal. In a third example, control logic 58 outputs control signal RSEL to calibrate the resistance of resistor network 62 based on the CODE signal.

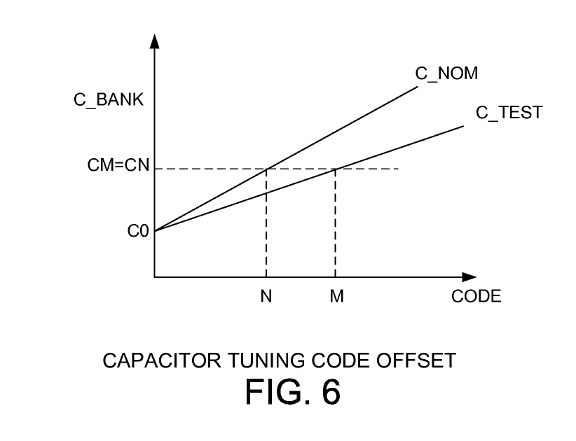

In the first example, digital baseband IC 20 communicates a new capacitor selection code based on the benchmark value, λ, as part of the CODE signal communicated to control logic 58. In this manner, benchmark value, λ, can be used to compensate for changing capacitance due to variations in conditions. FIG. 6 illustrates a plot of the capacitance of the tunable capacitor network 63 as a function of capacitor tuning code. In the present example, the capacitor tuning code has a range between 0 and 127 (a bank with 7 bit resolution). With the tuning code set to zero (e.g. each capacitor switch is open), the capacitor bank exhibits some parasitic capacitance, Cₚ. The capacitance of the capacitor bank (C_bank) increases linearly as a function of tuning code. Under nominal conditions (e.g. average factory conditions), the capacitance of the bank follows the “C_nom” line illustrated. As the tuning code is incremented by one, an additional MOM unit capacitor is added to the bank by closing its capacitor switch. Thus, under nominal conditions for a tuning code “N” the capacitance of the capacitor bank may be expressed as follows:

C_{bank,nom}=NC_{MOM,nom}+C_{p,nom} (17)

However, as conditions change, the capacitance of each MOM unit capacitor also changes. As the tuning code is incremented, the amount of additional bank capacitance contributed by each MOM unit capacitor changes. During test conditions, the capacitance follows the “C_test” line illustrated. Under test conditions for a tuning code “M” the capacitance of the capacitor bank may be expressed as follows:

C_{bank,test}=MC_{MOM,test}+C_{p,test} (18)

The benchmark value, λ, can be used to calculate the capacitor tuning code “M” that will provide the same capacitance as provided by capacitor tuning code “N” under nominal conditions. Under the assumption that the difference in parasitic capacitance under nominal and test conditions is negligible, the bank capacitance under test conditions with tuning code “M” is equated with the bank capacitance under nominal conditions with tuning code “N”. Tuning code “M” may be expressed as follows:

$$M \approx N \frac{{C}_{MOM , nom}}{{C}_{MOM , test}} = λ N \qquad ( 19 )$$

To compensate for changes in conditions, the code of a bank of MOM capacitors operating under conditions present during test is calculated as the benchmark value, λ, multiplied by the code of the same bank of MOM capacitors operating under nominal conditions.

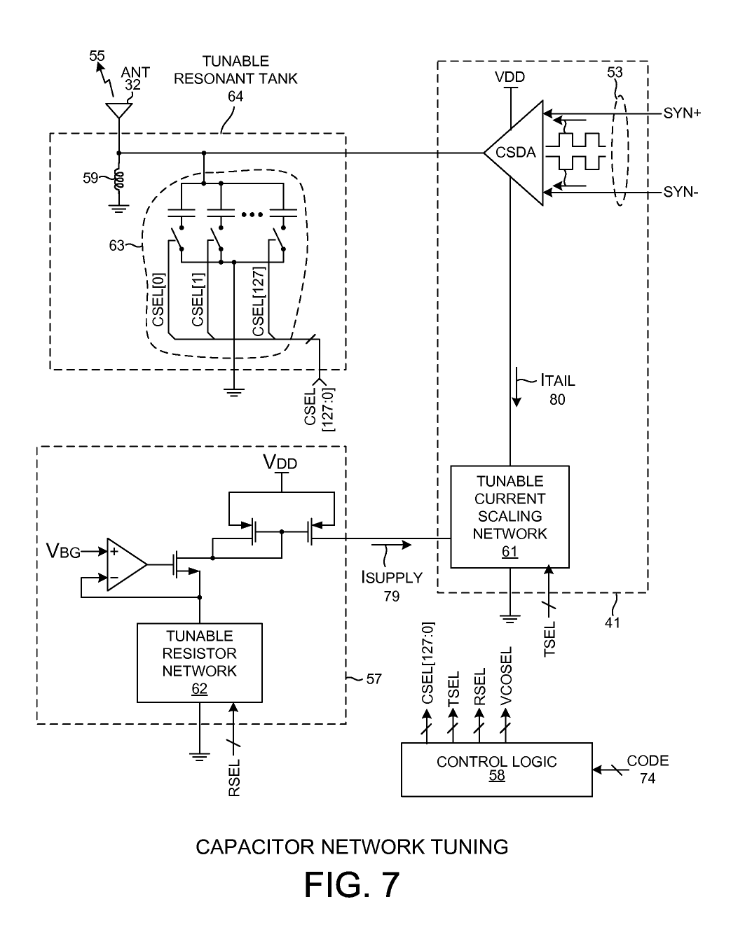

In the present example, new capacitor tuning code “M” is communicated to control logic 58. Control logic 58 communicates this code as a binary digital control signal CSEL useable to adjust the capacitance of tunable capacitor network 63 by changing the configuration of tunable capacitor network 63. FIG. 7 illustrates tunable capacitor network 63 in one example. Tunable capacitor network 63 includes one hundred twenty eight MOM capacitors arranged in parallel. The capacitors are selected in coordination with inductor 59 of resonant tank 64 to achieve a desired oscillation frequency, for example, 76 MHz-108 MHz. In one example, inductor 59 exhibits an inductance of approximately 150 nanohenries. The capacitance of each capacitor is either included or excluded from the network by operation of an associated switching component. As a switch associated with a particular capacitor is closed, the capacitance of that capacitor is included as part of the capacitance of the network. In the present example the capacitance value of each capacitor is approximately one quarter picofarad. In the present example, each bit of control signal CSEL communicated from control logic 58 addresses a corresponding switching component of network 63. In this manner, the resonant frequency of LC tank 64 is calibrated based at least in part on the benchmarking metric values generated by BMMM 43.

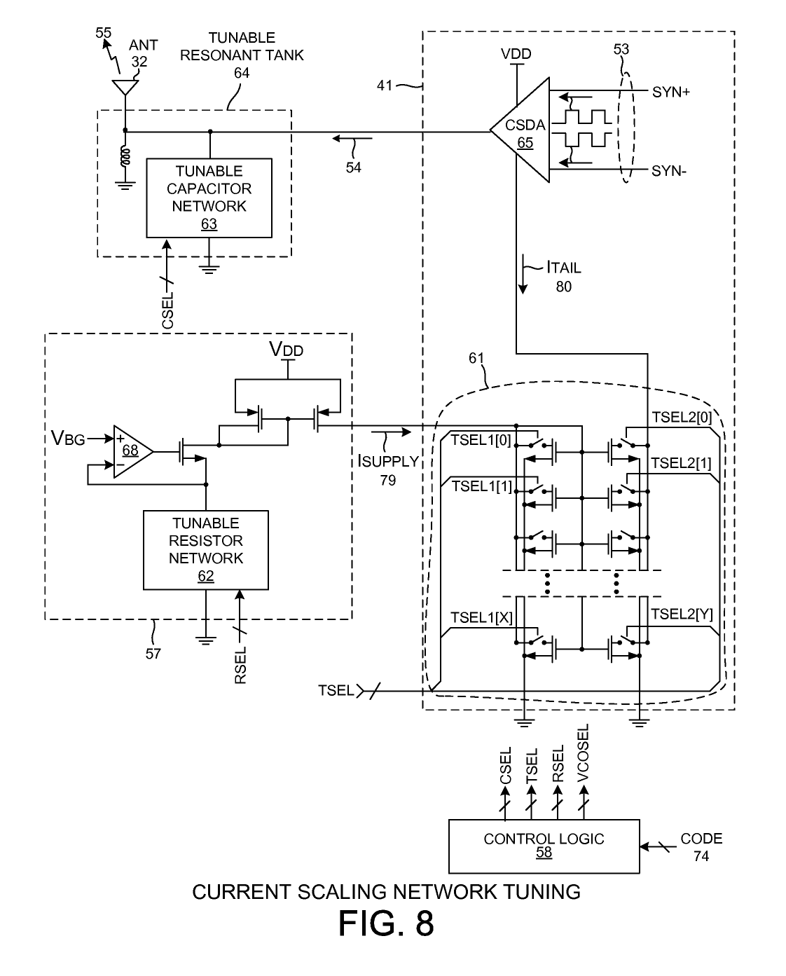

In the second example, digital baseband IC 20 communicates a new transistor selection code based on the benchmark value, γ, as part of the CODE signal communicated to control logic 58. In this manner, benchmark value, γ, can be used to compensate for changing current levels due to variations in conditions. FIG. 8 illustrates power amplifier 41 in greater detail. Power amplifier 41 includes a Current Switching Driving Amplifier (CSDA) 65. CSDA 65 receives synthesizer signal 53 and outputs radio transmission 54. Synthesizer signal 53 is a differential signal communicated as two signals in antiphase, SYN+ and SYN−. To minimize the amplitude variation of radio transmission signal 54, CSDA 65 requires that tail current 80 be maintained at a constant level. In the present example, the variation of tail current 80 must be maintained within a six percent range to maintain the output voltage variation of FM transmission 55 within 4 dB in the 76 MHz to 108 MHz frequency band. Typically, supply current 79 supplied by central bias generator 57 varies in a thirty percent range. To maintain a relatively constant tail current 80 in the face of varying supply current 79, a tunable current scaling network 61 is employed. Network 61 includes two banks of transistors. The transistors of each bank are arranged in parallel. By adjusting the number of transistors participating in each bank, tail current 80 can be scaled as a function of supply current 79. In the illustrated example, X+1 transistors are selectively coupled in parallel between central bias generator 57 and ground. Supply current scaling code, TSEL1, selects the number of transistors coupled in parallel, and thus determines the supply current scaling, CS_{supply}. Similarly, Y+1 transistors are selectively coupled in parallel between CSDA 65 and ground. Tail current scaling code, TSEL2, selects the number of transistors coupled in parallel, and thus determines the tail current scaling, CSₜₐᵢₗ. The tail current is related to the supply current by current scaling ratio, CSₜₐᵢₗ/CS_{supply}, as follows:

$$\frac{{I}_{Tail}}{{I}_{Supply}} = \frac{{CS}_{Tail}}{{CS}_{Supply}} \qquad ( 20 )$$

Central bias generator 57 includes operational amplifier 68 and a tunable resistor network 62 with a resistance, R_{network}. Under test conditions, amplifier 68 and network 62 generate current from a bandgap voltage source, V_{BG}, present on FM transceiver IC 12 as follows:

$${I}_{Supply , test} = \frac{{V}_{BG}}{{R}_{network , test}} \qquad ( 21 )$$

Under nominal conditions, amplifier 68 and network 62 generate current from a bandgap voltage source, V_{BG}, present on FM transceiver IC 12 as follows:

$${I}_{Supply , nom} = \frac{{V}_{BG}}{{R}_{network , nom}} \qquad ( 22 )$$

Under the assumption that the bandgap voltage, V_{BG}, is relatively stable in the face of changing conditions, the ratio of supply current under nominal conditions to the supply current under test conditions can be related to benchmark value, γ, as follows:

$$\frac{{I}_{Suppy , nom}}{{I}_{Supply , test}} = \frac{{R}_{network , test}}{{R}_{network , nom }} = \frac{{R}_{unit , test}}{{R}_{unit , nom}} \frac{{RSEL}_{nom}}{{RSEL}_{test}} = γ \frac{{RSEL}_{nom}}{{RSEL}_{test}} \qquad ( 23 )$$

In this example, tunable resistor network 62 includes a number of unit resistors arranged in parallel. Switching elements under the control of binary control signal RSEL determine whether each unit resistor participates in the network. The resistance of tunable network 62, R_{network}, is the resistance of a unit resistor, Rᵤₙᵢₜ, divided by the number of unit resistors participating in the network as determined by control signal RSEL. In this example, tunable resistor network 62 is not tuned. Thus, the same control signal is used under both nominal and test conditions. Under these conditions, the following relationship exists.

$$\frac{{I}_{Supply , nom}}{{I}_{Supply , test}} = γ \qquad ( 24 )$$

The change in supply current 79 is approximated by benchmark parameter, γ. Because tail current is related to supply current directly by the current scaling ratio, benchmark parameter, γ, may be used to adjust the current scaling ratio to compensate of changes in supply current and maintain a constant tail current. By equating the tail current under test conditions with the tail current under nominal conditions, the current scaling ratio under test conditions can be calculated from the current scaling ratio under nominal conditions and benchmark parameter, γ, as follows:

$${I}_{Tail , test} = {{I}_{Tail , nom} \\ ( \frac{{CS}_{Tail}}{{CS}_{Supply}} )}_{test} {I}_{Supply , test} = {( \frac{{CS}_{Tail}}{{CS}_{Supply}} )}_{nom} {{I}_{Supply , nom} \\ ( \frac{{CS}_{Tail}}{{CS}_{Supply}} )}_{test} = {γ ( \frac{{CS}_{Tail}}{{CS}_{Supply}} )}_{nom} \qquad ( 25 )$$

In the present example, a new transistor tuning code based on benchmark value, γ, is communicated to control logic 58. Control logic 58 communicates this code as a binary digital control signal TSEL useable to adjust the number of transistors participating in each bank of tunable current scaling network 61 based on scaling factor, γ.

Table 2 illustrates the performance improvements of FM transceiver IC 12 by using benchmark values λ and γ to calibrate tunable capacitor network 63 and tunable current scaling network 61 as discussed above. By applying a new capacitor tuning code M, the output voltage variation of FM transmitter 40 was reduced from 10.94 dB to 4.05 dB. By applying a new current scaling ratio to tunable current scaling network 61, a further reduction of output variation to 3.6 dB was achieved.

TABLE 2

| Proc | Typ | Fast | Fast | Fast | Fast | Slow | Slow | Slow | Slow | Output |
|---|---|---|---|---|---|---|---|---|---|---|
| Temp | Typ | HT | HT | LT | LT | HT | HT | LT | LT | Variation |
| Volt | Typ | HV | LV | HV | LV | HV | LV | HV | LV | (max-min) |
| None | −5.09 | −8.96 | −9.34 | −9.19 | −9.60 | 14.82 | 15.53 | 15.19 | 16.03 | 10.94 dB |
| λ | −5.09 | −5.33 | −5.72 | −6.72 | −7.12 | −8.43 | −9.14 | −7.33 | −8.20 | 4.05 dB |
| λ + γ | −5.09 | −6.31 | −6.71 | −7.21 | −7.62 | −7.97 | −8.69 | −6.47 | −7.33 | 3.6 dB |

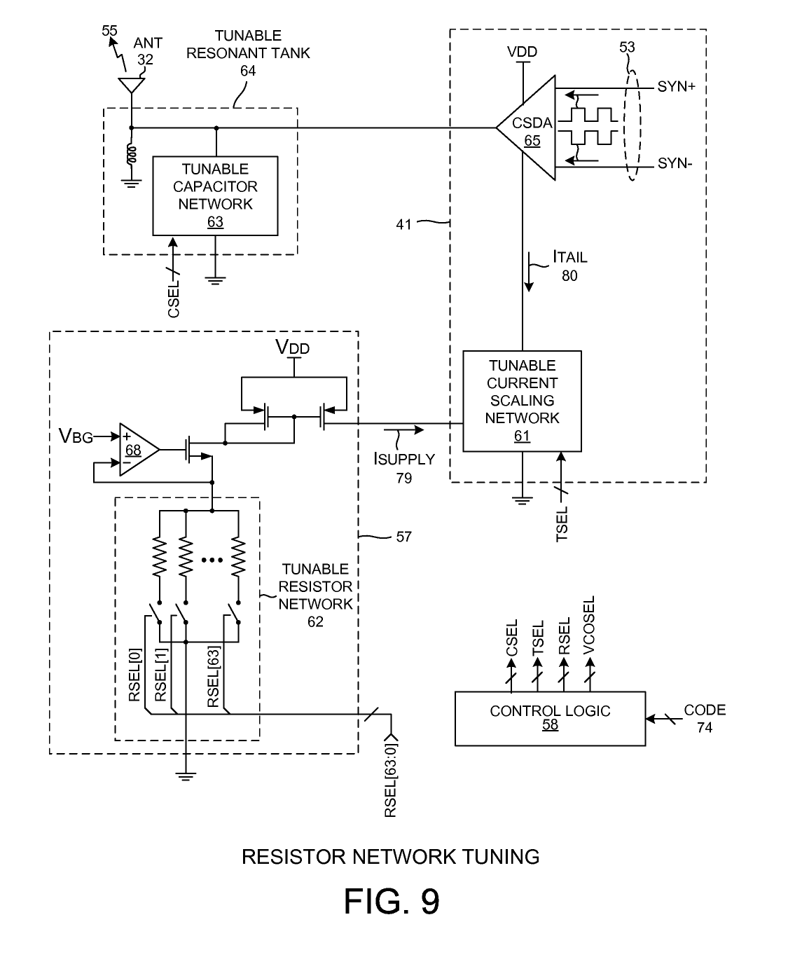

In the third example, digital baseband IC 20 communicates a new resistor selection code based on the benchmark value, γ, as part of the CODE signal communicated to control logic 58. In this manner, benchmark value, γ, can be used to compensate for changes in resistance due to variations in conditions. FIG. 9 illustrates central bias generator 57 in greater detail. As discussed above, central bias generator 57 includes operational amplifier 68 and a tunable resistor network 62 with a resistance, R_{network}. In this example, tunable resistor network 62 includes a number of unit resistors arranged in parallel. Switching elements under the control of binary control signal RSEL determine whether each unit resistor participates in the network. The resistance of tunable network 62, R_{network}, is the resistance of a unit resistor, Rᵤₙᵢₜ, divided by the number of unit resistors participating in the network as determined by control signal RSEL. The resistance of each unit resistor of tunable resistor network 62 varies as conditions change. Benchmark value, γ, can be used to compensate for variation in the resistance of tunable resistor network 62 directly to maintain a constant supply current. It is desired to maintain the same supply current under both nominal and test conditions.

I_{Supply,test}=I_{Supply,nom} (26)

Combining the desired relationship of equation (26) with equations (14) and (23), the following result is obtained.

$$\frac{{I}_{Supply , nom }}{{I}_{Supply , test}} = \frac{{R}_{network , test}}{{R}_{network , nom }} = \frac{{R}_{unit , test}}{{R}_{unit , nom}} \frac{{RSEL}_{nom}}{{RSEL}_{test}} = γ \frac{{RSEL}_{nom}}{{RSEL}_{test}} = 1 \qquad ( 27 )$$

Thus, a new resistor bank code may be calculated based on benchmark parameter, γ, and a nominal value of the resistor bank code.

RSELₜₑₛₜ=γRSELₙₒₘ (28)

Processor 21 calculates a new resistor bank code by scaling the initial resistor bank code by γ, as illustrated in equation (28), such that the resistance of network 62 is maintained at the same value in the face of changes in conditions. In this manner, supply current 79 is maintained at the same value in the face of changes in conditions. In the present example, a new current scaling tuning code is communicated to control logic 58. Control logic 58 communicates this code as a binary digital control signal RSEL useable to change the configuration of tunable resistor network 62 by adjusting the number of resistors participating in tunable resistor network 62 based on benchmark value, γ.

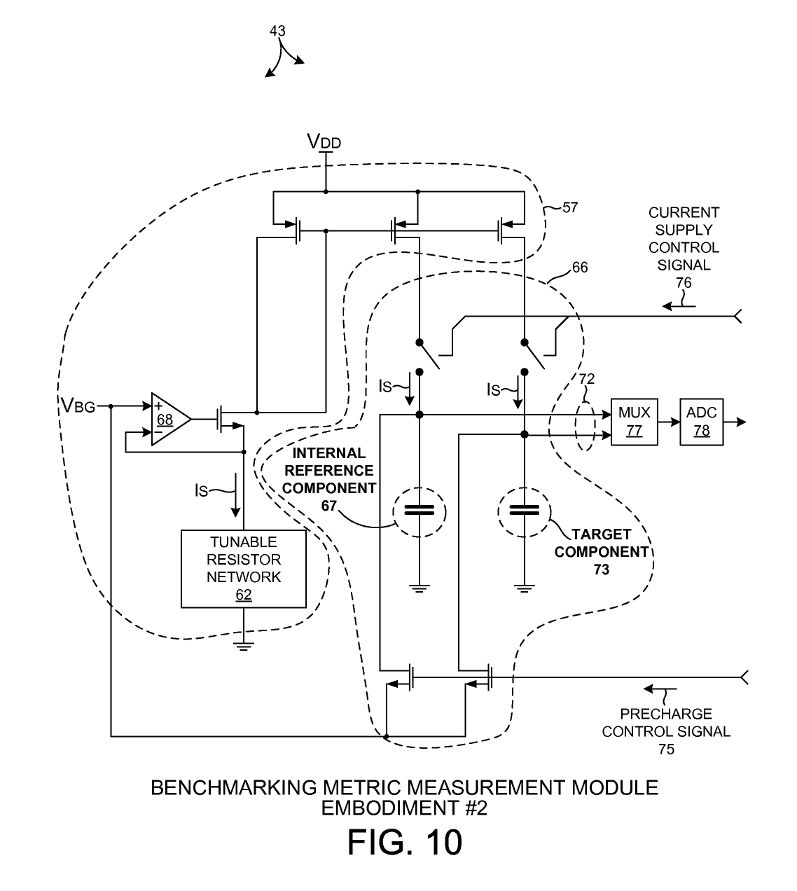

FIG. 10 illustrates a second embodiment of BMMM 43 operable to generate benchmarking metric values useable to calculate a benchmark value. The present embodiment of BMMM 43 includes central bias generator 57 and a second embodiment of benchmarking circuit 66. In the illustrated example, a supply current is generated by central bias generator 57. The supply current is communicated to two capacitor networks. The first capacitor network is an internal reference component 67. In the present example, the internal reference component includes at least one MOS capacitor. The second capacitor network is a target component 73 to be benchmarked to the internal reference component 67. In the present example, the target component includes at least one MOM capacitor. A precharge control signal 75 is communicated to BMMM 43 from processor 21. The precharge control signal 75 causes the bandgap voltage to be communicated to both capacitor networks. Thus, both capacitor networks are precharged to the same voltage level. The voltage level is selected such that the MOS capacitor is driven in a region of operation where non linearity is not significant. After the precharge is complete, the precharge control signal is released. A current supply control signal 76 is communicated to BMMM 43 from processor 21. The current supply control signal causes supply currents from central bias generator 57 to charge both capacitor networks for the same fixed amount of time. After the fixed period of time, a signal indicative of the potential across each capacitor is generated by benchmarking circuit 66. In the present embodiment, the benchmarking metric is the potential across a capacitor network and the benchmarking metric values 72 are the potential across the MOS capacitor 67 and the potential across the MOM capacitor 73. These values are multiplexed by multiplexer 77 and converted to digital code by analog to digital converter 78. The resulting codes indicative of the benchmarking metric values 72 are communicated to digital baseband IC 20 over I2C bus 51. Because, the charging conditions of both the MOS and MOM capacitors are nearly identical, the ratio of the potential across each capacitor is equivalent to the inverse of the ratio of the capacitance of each capacitor. Under test conditions, the relationship may be expressed as:

$$\frac{{V}_{MOM , test} - {V}_{BG}}{{V}_{MOS , test} - {V}_{BG }} = \frac{{C}_{MOS , test}}{{C}_{MOM , test}} \qquad ( 29 )$$

Under nominal conditions, the relationship may be expressed as:

$$\frac{{V}_{MOM , nom} - {V}_{BG}}{{V}_{MOS , nom} - {V}_{BG}} = \frac{{C}_{MOS , nom}}{{C}_{MOM , nom}} \qquad ( 30 )$$

Benchmark value, λ, defined in equation (10), can be rewritten as a function of ratio of the potential across both the MOS and MOM capacitors under both nominal and test conditions. Starting with the definition of benchmark value, λ, defined in equation (10) and using equations (29) and (30), we arrive at the following relation.

$$λ = \frac{{C}_{MOM , nom}}{{C}_{MOM , test}} = \frac{( {V}_{MOS , nom} - {V}_{BG} )}{( {V}_{MOM , nom} - {V}_{BG} )} \frac{( {V}_{MOM , test} - {V}_{BG} )}{( {V}_{MOS , test} - {V}_{BG} )} \frac{{C}_{MOS , nom}}{{C}_{MOS , test}} \qquad ( 31 )$$

Benchmark value, λ, may be expressed as a function of the ratio of the benchmark metric values 72 generated by benchmarking circuit 66 under nominal conditions and under test conditions. Noting that the capacitance of a MOS capacitor under nominal conditions is approximately the same as its capacitance under test conditions, benchmark value, λ, may be expressed as:

$$λ \approx \frac{( {V}_{MOS , nom} - {V}_{BG} )}{( {V}_{MOM , nom} - {V}_{BG} )} \frac{( {V}_{MOM , test} - {V}_{BG} )}{( {V}_{MOS , test} - {V}_{BG} )} \qquad ( 32 )$$

In this manner, benchmark value, λ, is calculated based on the benchmarking metric values 72. Furthermore, the calculated benchmark value, λ, is useable to calibrate a tunable circuit element such as tunable capacitor network 63 in the same manner as discussed above.

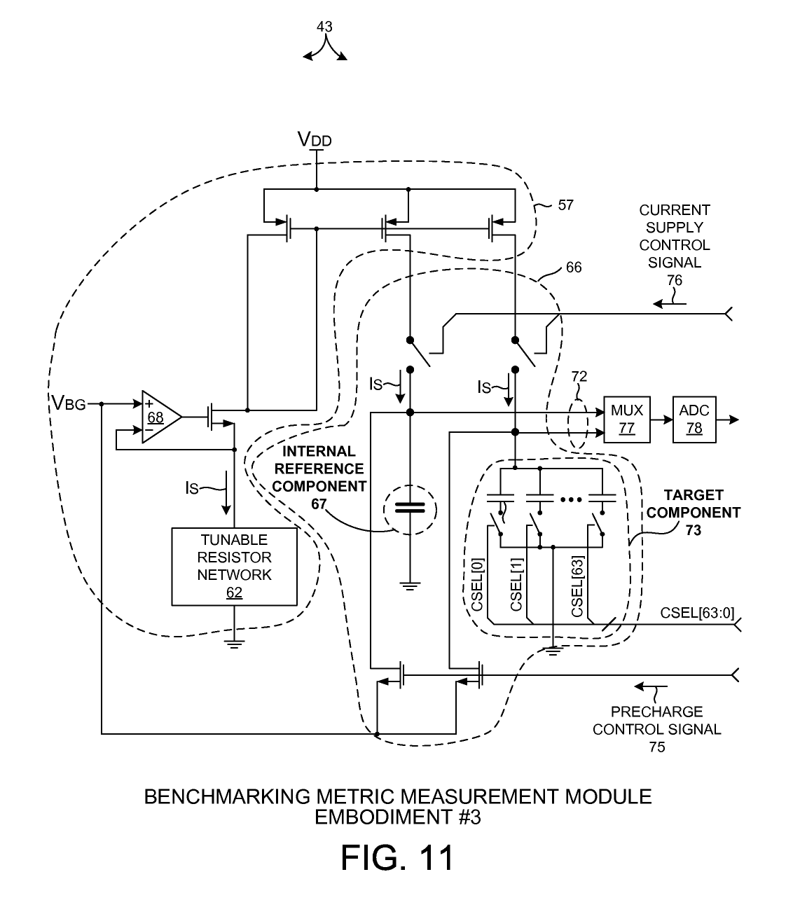

FIG. 11 illustrates a third embodiment of BMMM 43 operable to generate benchmarking metric values useable to benchmark a target component to an internal reference component. The present embodiment of BMMM 43 is similar to the second embodiment described above, except the target component 73 includes a tunable capacitor network of MOM capacitors and the internal reference component 67 includes at least one MOS capacitor. In addition, a capacitor selection signal, binary digital control signal CSEL, is received by BMMM 43 and determines a configuration of the tunable capacitor network 73. As discussed above, a signal indicative of the potential across each capacitor network is generated by benchmarking circuit 66. The benchmarking metric is the potential across a capacitor network and the benchmarking metric values 72 are the potential across the MOS capacitors 67 and the potential across the tunable network of MOM capacitors 73. In the present embodiment, the values 72 are communicated to digital baseband IC 20, where processor 21 executes a tuning algorithm stored in program memory 23 that first determines a difference between the two benchmarking metric values to generate a benchmark value. In this manner, benchmark value, λ, is calculated based on the benchmarking metric values 72. In one example, the benchmarking metric values are communicated to digital baseband IC 20 as digital codes and processor 21 takes the difference between the values to calculate the benchmark value. In another example, benchmarking circuit 66 includes an analog comparator (not shown) that generates a difference value between the two benchmarking metric values. This difference value is converted into a digital code by ADC 78 and the resulting code is communicated to digital baseband IC 20. Next, a tuning algorithm selects a new code based on the benchmark value representative of the difference in potential between MOS capacitor 67 and the tunable capacitor network 73. In one example, processor 21 may execute a binary search over the tuning code of the tunable capacitor network of MOM capacitors based on the benchmark value. The new capacitor selection code is communicated to BMMM 43 as binary digital control signal CSEL and the configuration of tunable capacitor network 73 is changed in response to control signal CSEL. The test is repeated until the voltage difference between the two capacitor networks converges. At this point, the capacitance of the target component 73 is calibrated such that it is approximately the same as the capacitance of the internal reference component 67. Thus, BMMM 43 and the tuning algorithm executed by processor 21 work together to iteratively benchmark the capacitance of the tunable MOM capacitor network 73 to the capacitance of the MOS capacitor network 67 and then calibrate the MOM network 73 to match the capacitance of the MOS network 67. After tuning the MOM capacitor network 73, resistance tuning can be performed. In one example, resistance tuning may be performed as described above using the benchmarking circuit 66 of FIG. 3 where the internal reference component 67 utilized in the benchmarking circuit 66 of FIG. 3 is made up of either a MOS capacitor or the tuned MOM capacitors. In other examples, resistance tuning may be performed by other circuitry operable to perform the task.

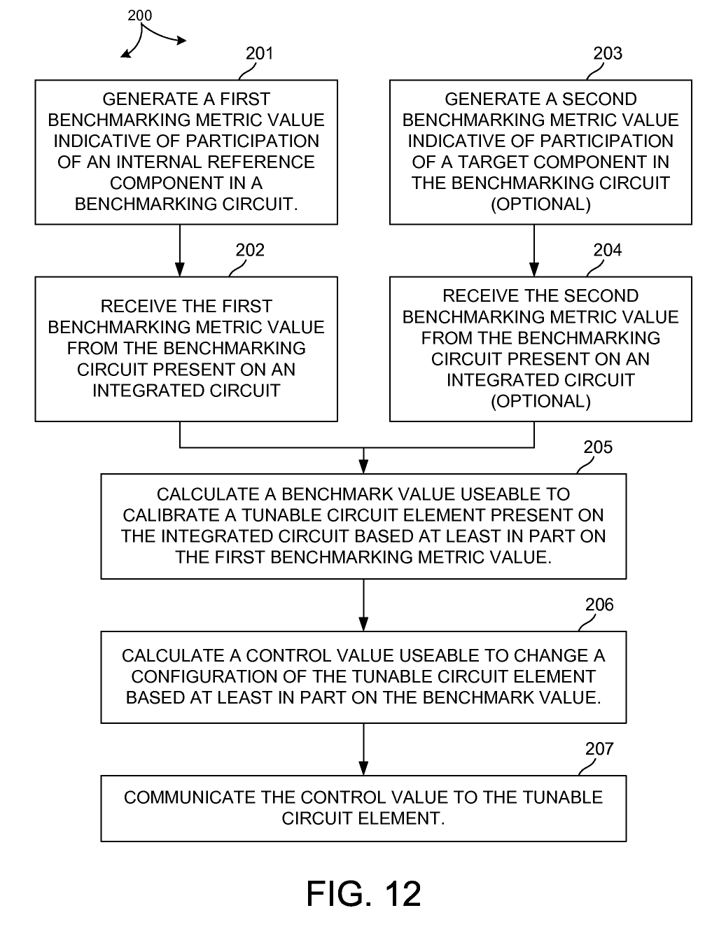

FIG. 12 illustrates a flowchart of a method 200 of benchmarking target components of an IC with an internal reference component of the IC. In a first step (step 201), a first benchmarking metric value is generated by a benchmarking circuit, where an internal reference component participates in the benchmarking circuit. In a second step (step 202), the first benchmarking metric value is received from the benchmarking circuit. In optional steps 203-204, a second benchmarking metric value is generated by the benchmarking circuit, where an target component participates in the benchmarking circuit (step 203), and this second benchmarking metric value is received from the benchmarking circuit (step 204). In a third step (step 205), a benchmark value is calculated based on the first benchmarking metric value, or optionally, on both the first and second benchmarking metric values. The benchmark value is useable to calibrate a tunable circuit element on the IC. In a fourth step (step 206), a control value is calculated based at least in part on the benchmark value. The control value is useable to change the configuration of the tunable circuit element. In a fifth step (step 207) the control value is communicated to the tunable circuit element.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. RF transceiver IC 11 and FM transceiver IC 12 are described above as being separate integrated circuits. In another embodiment, however, RF transceiver IC 11 and FM transceiver IC 12 are integrated into the same integrated circuit. In yet another embodiment, both the analog and the digital functions of mobile communication device 10 are performed on a single integrated circuit, called a system on a chip (SOC). In the SOC implementation, RF transceiver IC 11, FM transceiver IC 12 and digital baseband IC 20 are all integrated onto the same integrated circuit. In another example, processor 21 of digital baseband IC 20 executes code stored in memory 23 to perform many actions described above. In another embodiment, however, the actions described above as being performed by processor 21 might be performed by a processor on board FM transceiver IC 12, such as DSP 44 or DSP 45. In yet another embodiment, the actions described above as being performed by processor 21 might be performed by a processor within BMMM 43. In yet another embodiment, the actions described above as being performed by processor 21 might be performed by an amount of digital logic on board FM transceiver IC 12, or more specifically, within BMMM 43. Similarly, the code and values described above as stored in memory 22 and values stored in memory 46 may be stored in memories located on FM transceiver IC 12, or more specifically, within BMMM 43. Accordingly, various modifications, adaptations, and combinations of the various features of the described specific embodiments can be practiced without departing from the scope of the claims that are set forth below.

What is claimed is:

1. A method comprising:
receiving a first benchmarking metric value from a benchmarking circuit present on an integrated circuit; and
determining a benchmark value useable to calibrate a tunable circuit element present on the integrated circuit based at least in part on the first benchmarking metric value.

2. The method of claim 1, further comprising:
generating the first benchmarking metric value by measuring a benchmarking metric of the benchmarking circuit, wherein the first benchmarking metric value is indicative of participation of an internal reference component in the benchmarking circuit.

3. The method of claim 2, wherein the internal reference component includes a capacitor of a first type, and wherein the tunable circuit element includes a capacitor of a second type.

4. The method of claim 2, wherein the first benchmarking metric value is a count value, and wherein the benchmarking metric is indicative of an oscillation frequency of the benchmarking circuit.

5. The method of claim 2, further comprising:
generating a second benchmarking metric value by measuring the benchmarking metric of the benchmarking circuit, wherein the second benchmarking metric value is indicative of participation of a target component in the benchmarking circuit.

6. The method of claim 5, wherein the internal reference component includes a capacitor of a first type, wherein the target component includes a first capacitor of a second type, and wherein the tunable circuit element includes a second capacitor of the second type.

7. The method of claim 5, wherein the internal reference component exhibits a lower sensitivity to changes in process and temperature than the target component.

8. The method of claim 1, wherein the receiving and the determining are performed on the integrated circuit.

9. The method of claim 5, wherein the determining of the benchmark value involves determining a ratio of the first and second benchmarking metric values, and wherein the determining of the ratio cancels systemic, parasitic errors of the benchmarking circuit.

10. The method of claim 5, wherein the determining of the benchmark value involves determining a difference between the first and second benchmarking metric values.

11. The method of claim 1, further comprising:
determining a control value useable to change a configuration of the tunable circuit element present on the integrated circuit based at least in part on the benchmark value; and
communicating the control value to the tunable circuit element.

12. The method of claim 11, wherein the determining of the control value involves multiplying a capacitor bank code of a tunable capacitor network with the benchmark value.

13. The method of claim 1, wherein the tunable circuit element is taken from the group consisting of: a tunable capacitor network, a tunable resistor network, and a tunable current scaling network.

14. An apparatus comprising:
a benchmarking circuit including an internal reference component and a target component, wherein the internal reference component participates in the benchmarking circuit in at least a first mode of the benchmarking circuit, wherein the target component participates in the benchmarking circuit in at least a second mode of the benchmarking circuit, and wherein the internal reference component exhibits a lower sensitivity to changes in test conditions than the target component.

15. The apparatus of claim 14, wherein the internal reference component includes a metal-on-silicon capacitor, and wherein the target component includes a metal-on-metal capacitor.

16. The apparatus of claim 14, further comprising:
a tunable circuit element, wherein the tunable circuit element is calibrated based at least in part on a benchmark value derived from an output of the benchmarking circuit.

17. The apparatus of claim 16, wherein the benchmarking circuit outputs a first benchmarking metric value and a second benchmarking metric value, and wherein the benchmark value is the ratio of the first and second values.

18. The apparatus of claim 16, wherein the tunable circuit element is calibrated by scaling a capacitor bank code of a tunable capacitor network with the benchmark value.

19. The apparatus of claim 14, wherein the benchmarking circuit includes a harmonic oscillator with selectable capacitors, wherein a set of selectable capacitors of a first type is the internal reference component, and wherein a set of selectable capacitors of a second type is the target component.

20. The apparatus of claim 19, wherein the first benchmarking metric value is indicative of a first time constant of the harmonic oscillator operating in the first mode, and wherein the second benchmarking metric value is indicative of a second time constant of the harmonic oscillator operating in the second mode.

21. The apparatus of claim 14, wherein the internal reference component includes a capacitor of a first type, wherein the target component includes a capacitor of a second type, and wherein the first benchmarking metric value is indicative of a potential across the internal reference component and the second benchmarking metric value is indicative of a potential across the target component.

22. An apparatus comprising:
a benchmarking circuit;
a tunable circuit element; and
means for receiving a first benchmarking metric value from the benchmarking circuit present on an integrated circuit and determining a benchmark value useable to calibrate the tunable circuit element present on the integrated circuit based at least in part on the first benchmarking metric value.

23. The apparatus of claim 22, wherein the means includes a processor in a second integrated circuit.

24. The apparatus of claim 22, wherein the means includes a processor in the integrated circuit.

25. The apparatus of claim 22, wherein the benchmarking circuit includes an internal reference component and a target component, wherein the internal reference component participates in the benchmarking circuit in at least a first mode of the benchmarking circuit, wherein the target component participates in the benchmarking circuit in at least a second mode of the benchmarking circuit, and wherein the internal reference component exhibits a lower sensitivity to changes in test conditions than the target component.

26. A computer-readable medium encoded with instructions capable of being executed by a computer, wherein execution of the instructions capable of being executed by the computer is for:
receiving a first benchmarking metric value from a benchmarking circuit present on an integrated circuit and determining a benchmark value useable to calibrate a tunable circuit element present on the integrated circuit based at least in part on the first benchmarking metric value.

27. The computer-readable medium of claim 26, wherein the computer includes a processor and a memory, and wherein the memory is the computer-readable medium and stores the code.

28. The computer-readable medium of claim 26, wherein execution of the instructions capable of being executed by the computer is further for:
determining a control value based at least in part on the benchmark value and communicating the control value to the tunable circuit element, wherein the control value is useable by the tunable circuit element to change a configuration of the tunable circuit element.

29. The computer-readable medium of claim 26, wherein the benchmarking circuit includes an internal reference component and a target component, wherein the internal reference component participates in the benchmarking circuit in at least a first mode of the benchmarking circuit, wherein the target component participates in the benchmarking circuit in at least a second mode of the benchmarking circuit, and wherein the internal reference component exhibits a lower sensitivity to changes in test conditions than the target component.
